(19) United States
(12) Patent Application Publication
(10) Pub. No.: US 2017/0355299 A1
(43) Pub. Date: Dec. 14, 2017

(54) ACTIVE LOADING SURFACE LIMITER

(71) Applicant: FORD GLOBAL TECHNOLOGIES, LLC, Dearborn, MI (US)

(72) Inventors: Igor Fischbein, Cologne (DE); Gurinder Sodhi, Troy, MI (US); Paul Folmering, Cologne (DE); Manas R. Baykadi, Plymouth, MI (US)

(21) Appl. No.: 15/611,206

(22) Filed: Jun. 1, 2017

(30) Foreign Application Priority Data
Jun. 9, 2016 (DE) 102016210189.7

(51) Int. Cl. B60P 7/15; B62D 33/08

(52) U.S. Cl. CPC B60P 7/15; B62D 33/08

(57) ABSTRACT

A limiting device for a loading area of a motor vehicle is provided. The limiting device has a height which is adjustable relative to a loading surface and may be set to a specific height according to the height of the loaded objects. A method is also provided by which the loading area of the motor vehicle is able to be loaded and unloaded.

### TECHNICAL FIELD

This document relates to a limiting device for a loading area of a motor vehicle which has a height which is adjustable relative to the loading surface.

### BACKGROUND

Motor vehicles generally have a vehicle region for the transport of objects which is arranged in the rear part of a corresponding vehicle. Particularly station wagons and vehicles of the SUV type (sport utility vehicle) are frequently used for the transport of loose objects, such as for example luggage items, sports items or items of daily use and have correspondingly large loading areas. High sills such as for example in conventional trunks of limousines, however, are particularly inconvenient for heavy loads. In order to permit easy loading and unloading of objects from a loading area which is suitable therefor, loading areas of station wagons and SUVs, therefore, frequently have no sill or a low sill. With sills which are low or not even present, however, objects, particularly small, loose and round objects may easily fall out of the loading area and become damaged at the same time. The object of the limiting device, therefore, is to prevent objects from falling out of a loading area.

### SUMMARY OF THE INVENTION

This object is achieved by a limiting device having the features described herein.

A first feature relates to a limiting device for a loading area of a motor vehicle. The loading area comprises a loading surface and at least one wall which defines the loading area and extends upright. One side of the loading area is accessible for loading and unloading via an access device. The limiting device is arranged on the accessible side and has a height which is adjustable relative to the loading surface.

The limiting device advantageously permits the securing of loose objects against inadvertently falling out of the loading area when the access device is open.

Preferably, in the limiting device different heights are able to be set relative to the loading surface. Advantageously, therefore, the height of the limiting device is able to be set according to the type of objects located on the loading surface, for example the size or the geometric shape.

In this case the limiting device is preferably configured such that the height thereof is able to be set for loading and unloading, for example in the region of the loading surface. Advantageously, in this case the limiting device does not have a disruptive effect and is not subject to any risk of damage. In this case, “for example in the region of the loading surface” means that the limiting device is ideally lowered to the height of the loading surface or slightly above the loading surface, such that an undesirable blocking action does not occur. Advantageously, in this case the limiting device may be pulled into or folded into a recess in the loading surface.

Preferably, the height of the limiting device is able to be set at least to such a height that a movement of an object located on the loading surface in the direction of the access device is stopped. As a result, advantageously an object is effectively prevented from accidentally falling out when the access device is open.

Preferably, the limiting device is able to be actively height-adjusted upwardly and downwardly by an acting force. Particularly preferably, the limiting device has an elastic element which is elastically deformable by a force in one direction such that the height of the limiting device is approximately set to the height of the loading surface and which adopts its initial state without the force, so that the limiting device adopts a height dictated by the shape of the elastic element.

Preferred is an embodiment of the limiting device, the height thereof being adjustable by a manually exerted force.

Also preferred is an embodiment of the limiting device, the height thereof being adjustable by a mechanically exerted force. Particularly preferred in this case is an embodiment of the limiting device in which the height is automatically set when the closable access device is opened, such that a movement of an object located on the loading surface is stopped in the direction of the access device.

In accordance with an additional aspect, the limiting device comprises a body extending across the loading surface. That body is displaceable between a retracted position and a deployed position. The limiting device also includes an elastic element biasing the body toward the deployed position.

In some embodiments, the body is adjacent the sill of the loading area. The body extends above the loading surface when in the deployed position. The body may extend level with or below the loading surface when in the retracted position.

In some embodiments, the limiting device includes an indentation provided in one of the loading surface or the sill. The indentation may receive the body when the body is in the retracted position. In some embodiments, the limiting device further includes a handle carried on the body.

A second feature relates to a motor vehicle having a limiting device as described.

A third feature relates to a method for loading and unloading the loading area of a motor vehicle comprising a limiting device as described, having the steps:

loading the loading area,

deploying the limiting device,

closing the access device,

opening the access device,

lowering the limiting device,

unloading the loading area.

More specifically, the step of deploying the limiting device may include raising the limiting device so as to extend upward from the loading surface of the loading area. Further, the method may include the step of positioning the limiting device adjacent a sill of the loading area so that when the limiting device is deployed and raised from the loading surface, the limiting device acts as a stop to block objects from rolling across the sill when the access device is opened. Still further, the method may include the step of extending the limiting device continuously across the sill.

The advantages of the method correspond to the advantages of the limiting device.

### BRIEF DESCRIPTION OF THE DRAWING FIGURES

The limiting device and method are described in more detail with reference to the figures, in which:

FIG. 1 shows a schematic view of a conventional loading area;

FIG. 2 shows a schematic view of a conventional, loaded loading area;

FIG. 3a shows a schematic view of a loading area with a ramp-like embodiment of the limiting device;

FIG. 3b shows the embodiment of the limiting device according to FIG. 3a with an object pressing down the limiting device;

FIG. 3c shows the embodiment according to FIG. 3a in the blocked position;

FIG. 3d shows the embodiment according to FIG. 3a in the closed position;

FIG. 4a shows a schematic view of a loading area with a beam-like embodiment of the limiting device;

FIG. 4b shows the embodiment according to FIG. 4a with an object pressing down the limiting device;

FIG. 4c shows the embodiment according to FIG. 4a in the blocked position;

FIG. 5a shows a schematic view of a loading area with a board-like embodiment of the limiting device;

FIG. 5b shows the embodiment of FIG. 5a with an object pressing down the limiting device;

FIG. 5c shows the embodiment of FIG. 5a in the blocked position;

FIG. 6a shows a schematic view of a loading area with a board-like manually operable embodiment of the limiting device;

FIG. 6b shows the embodiment of FIG. 6a with an object pressing down the limiting device;

FIG. 6c shows the embodiment of FIG. 6b in the blocked position; and

FIG. 7 shows a flow diagram of an embodiment of the method.

### DETAILED DESCRIPTION

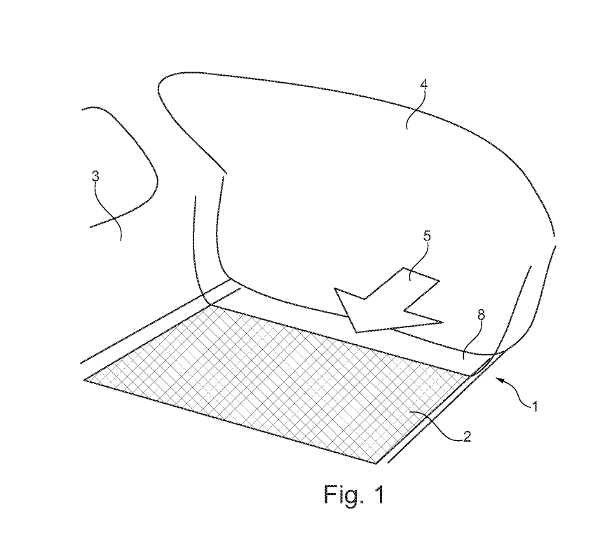

In the view according to FIG. 1, a loading area 1 of a vehicle comprises a loading surface 2. The loading area 1 is defined by at least one wall 3 adjoining the loading surface 2 and extending upright, i.e. perpendicular or approximately perpendicular to the loading surface. The wall 3 may be a wall of the motor vehicle or even a rear wall of a seat bench. The loading area 1 is accessible on at least one side. The accessible side is delimited by an access device 4 which is conventionally configured as a closable door or flap. The loading surface 2 is designed to be substantially flat, ideally entirely flat. A loading direction of the loading area 1 is indicated by the arrow 5.

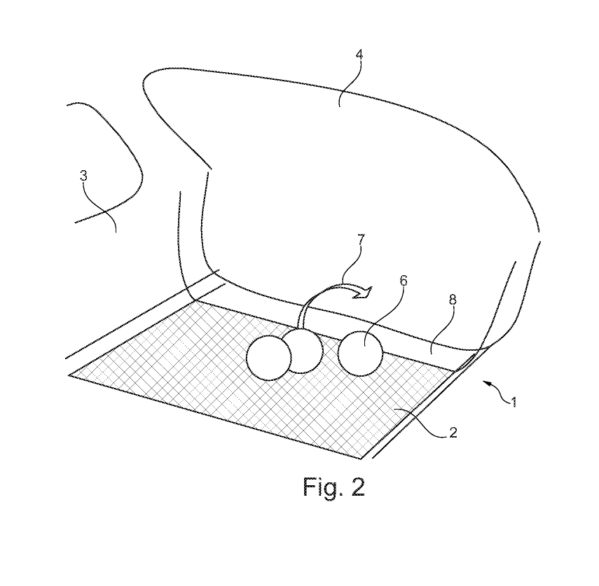

A loading area 1 with objects 6 which are located on the loading surface 2 is shown in FIG. 2. A direction in which objects 6, particularly objects of round shape, roll out or slip out of the loading area and thus inadvertently fall out and may become damaged is indicated by the arrow 7. In this case, the movement of objects 6 from the loading area 1 is facilitated by a sill 8 of the loading area 1 which is not present or by a low sill. The sill 8 is arranged in the region of the access device 4 for delimiting the loading surface 2.

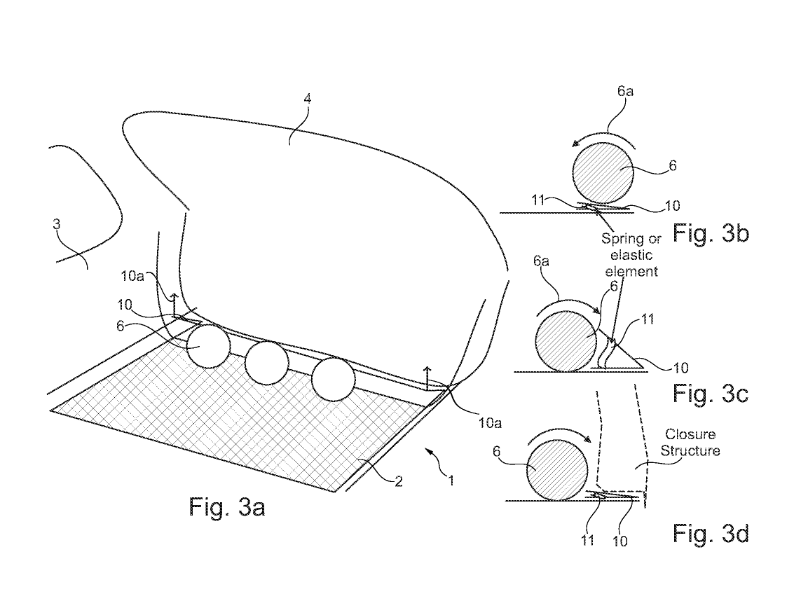

In the view of FIG. 3a, an embodiment of a limiting device 10 is arranged adjacent to or in the region of the sill 8. The limiting device 10 has a body that is ramp-like or, in other words, configured as a device in the form of a board or a flap which is able to be deployed, such that the opening of the ramp faces in the direction of the loading surface 2, i.e. of the loading area 1, and at the same time blocks a movement of an object from the direction of the loading surface 2. The lifting movement of the limiting device 10 is indicated by the arrows 10a. In this case the limiting device 10 comprises at least one elastic element 11, for example a spring 11. If a force acts on the device, for example due to the load of an object 6 which is pushed from the accessible side 4 onto the loading surface 2, the limiting device 10 is pressed down against the action of the spring 11 (FIG. 3b). The direction of movement of the object 6 is indicated by the arrows 6a. Without the action of an external force, i.e. for example that a load does not act on the limiting device 10, the limiting device 10 is deployed by the action of the spring 11, so that it blocks a movement from the loading surface 2 in the direction of the accessible side 4 (FIG. 3c). In one embodiment according to FIG. 3d, the limiting device 10 comprises a latching function which permits the limiting device 10 to remain in position when it is pressed down and in which a further pressing down effects a release of the limiting device 10 so that it once again blocks the loading surface. It is possible to imagine this, for example, as a push button of a ballpoint pen, in which repeated pressing permits the ink reservoir of the ballpoint pen to extend or retract.

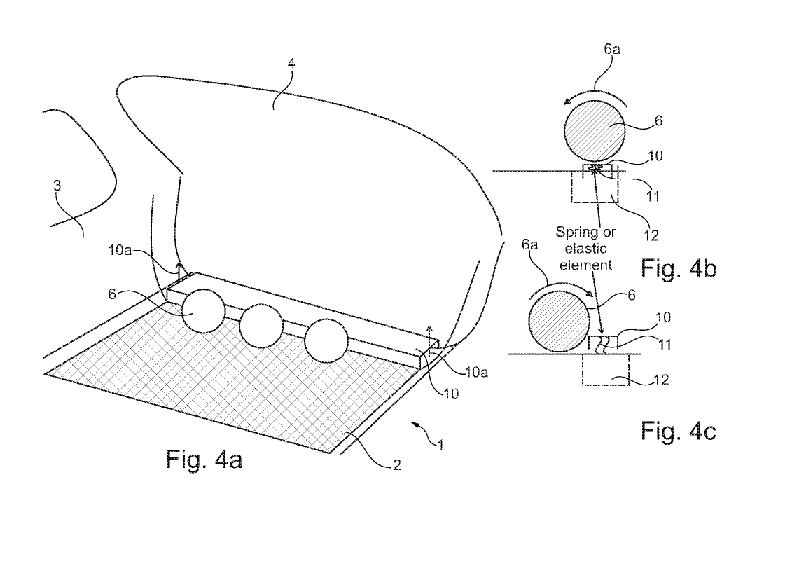

In this case the limiting device 10 is configured to reach a height so that it exceeds the height of the sill 8, such that objects are prevented from rolling out (FIG. 3a). For example the limiting device 10 is set to a height such that it is approximately level with the center of gravity of one or more objects 6 located on the loading surface 2; a lower height, however, is also sufficiently effective to stop a movement of the objects 6. The height of the limiting device 10 may, for example, be up to 10 cm above the height of the sill. One embodiment of the limiting device 10 according to the view of FIG. 4 is able to be adjusted in height in the vertical direction. The limiting device 10 is configured to be a rectangular parallelepiped, so that for example it may have the shape of a beam-like sill. Objects 6 may be effectively prevented thereby from rolling out or falling out, when it has been set to a corresponding height (FIG. 4a). As set forth for the embodiment according to FIG. 3, a height of a few centimeters, for example 10 cm, is sufficient therefor. Alternatively, in the embodiment according to FIG. 4 the limiting device 10 is adjustable to any height, in order to prevent effectively objects 6 on the loading surface 2 from falling out. The limiting device 10 in this embodiment is also connected to at least one elastic element 11 which may be a spring as in FIG. 3. This spring is arranged, for example, on the lower face of the limiting device 10 or integrated in the limiting device 10 as, in particular, may be seen in FIG. 4c. If a force acts on the device, for example by the load of an object 6, which is pushed from the direction of the accessible side 4 onto the loading surface 2, the limiting device 10 is pressed down against the action of the spring 11, i.e. for example lowered in a recess 12 provided therefor (4b). Without the action of an external force, i.e. for example no load acting on the limiting device 10, the limiting device 10 is lifted by the action of the spring so that it blocks the loading surface 2 in the direction of the accessible side 4 (FIG. 4c). In an embodiment equivalent to the view of FIG. 3d, the limiting device 10 in this case also has a latching function which permits the limiting device 10 to remain in position when it is pressed down, and in which further pressing down effects a release of the limiting device 10 so that it once again blocks the loading surface.

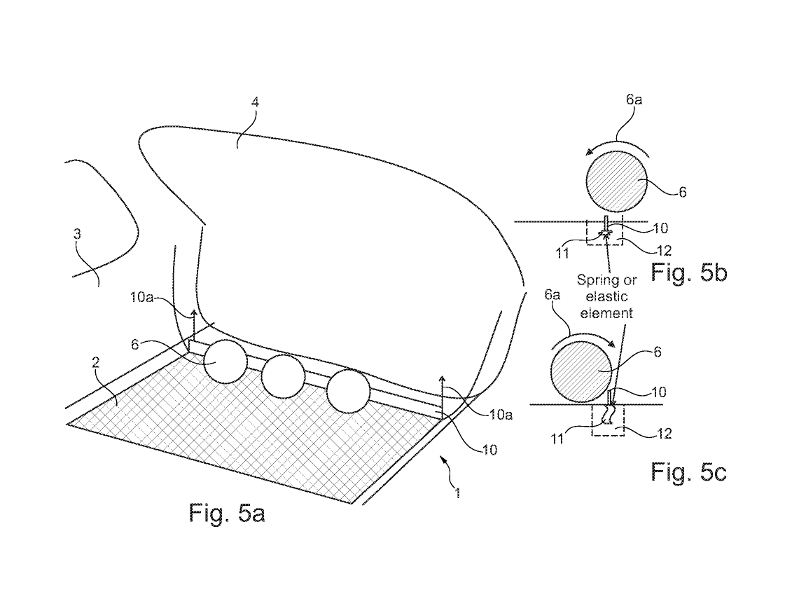

A further embodiment of the limiting device 10 which is able to be adjusted in height in the vertical direction is shown in FIG. 5, wherein the limiting device 10 in this case is narrower than in FIG. 4. The limiting device 10 in the embodiment according to FIG. 5 has the shape of a board which faces upwardly with the narrow long side and screens the loading area in a height-adjustable manner toward the accessible side. By setting the limiting device 10 to a specific height, objects 6 are not able to fall or roll out of the loading surface 2. To this end, in this embodiment the limiting device 10 is also connected to an elastic element 11 which may be a spring as in FIGS. 3 and 4. This spring is arranged, for example, on the lower face of the limiting device 10 or integrated in the limiting device 10, as may be seen in particular in FIG. 5c. If a force acts on the device, for example, by the load of an object 6 which is pushed from the direction of the accessible side 4 onto the loading surface 2, the limiting device 10 is pressed down counter to the action of the spring 11, i.e. for example lowered in a recess 12 provided therefor (FIG. 5b). Without the action of an external force, i.e. for example without a load acting on the limiting device 10, the limiting device 10 is lifted by the action of the spring, so that it blocks the loading surface 2 in the direction of the accessible side 4 (FIG. 5c). In an embodiment equivalent to the view of FIG. 3d the limiting device 10 in this case also has a latching function which permits the limiting device 10 to remain in position when it is pressed down, and in which when pressed down further effects a release of the limiting device 10 so that it once again blocks the loading surface.

In an alternative embodiment, the limiting device 10 is moved by the force of a motor (not shown), particularly an electric motor, i.e. adjusted in height. This possibility is particularly suitable for the embodiments of the limiting device 10 shown in FIGS. 4 and 5. To this end the limiting device 10 is coupled to the electric motor which, upon a control command, adjusts the height of the limiting device 10 upwardly or downwardly. In this case, the limiting device 10 is able to be adjusted to its greatest possible height, lowered in the recess 12 or set to any height between these positions. The corresponding control commands are preferably provided manually, for example by an input device, for example a switch which is arranged in the loading area.

It is also possible that the height is automatically set according to control commands provided by a control device (not shown). In this case, the control device may react to the open state of the access device 4. Preferably, the limiting device 10 is lowered when the access device 4 is closed, i.e. lowered in the recess 12. When the access device 4 is opened, the limiting device 10 is raised so that loose, particularly round, objects 6 are protected from falling out.

In a further embodiment, the limiting device 10 is able to be set, both automatically and manually, so that when the access device is opened the limiting device 10 is raised but may be lowered manually, if required.

In a further embodiment, a motor-driven limiting device 10 is also coupled to an elastic element 11. Thus, for example, it is possible that the limiting device 10 is raised by being driven by motor during opening and is pressed down counter to the force of the elastic element 11. This is advantageous, for example, during loading when, by the action of the load to be loaded, the limiting device is pressed down counter to the force of the elastic element during the actual loading time.

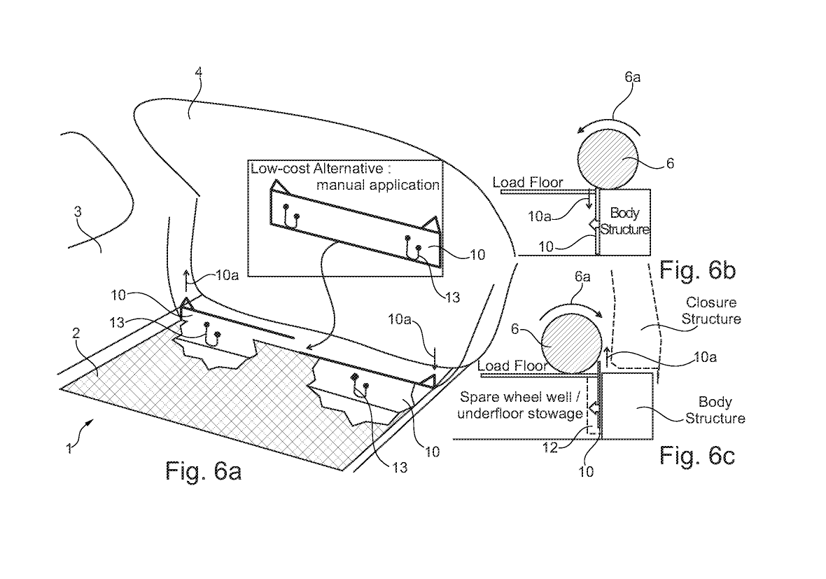

In a further embodiment according to the view of FIG. 6 the limiting device 10 is directly moved manually, i.e. it is adjustable in height by the manual action of force by a person. To this end, at least one handle 13, in the embodiment shown two handles 13, is/are arranged on the limiting device 10, the person being able to act thereon in order to adjust the limiting device 10 upwardly or downwardly. Ideally, in this embodiment devices for latching are arranged on the limiting device 10, said devices permitting different heights to be set.

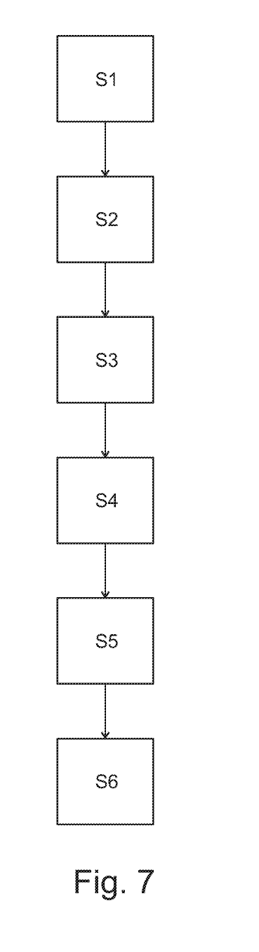

In a method according to an embodiment according to FIG. 7 for loading a loading area 1, in a first step S1 the loading area 1 is loaded, i.e. at least one object 6 is moved onto the loading surface 2. At the same time, the limiting device 10 is pressed down by means of the object 6 counter to the force of the spring 11, or lowered manually or mechanically. In a second step S2, the limiting device 10 is manually or mechanically raised by the force of the spring 11 to a sufficient extent that objects present on the loading surface are not able to fall out, and in particular round objects are not able to roll out. In a third step S3, the access device located on the accessible side 4 is closed. In a fourth step S4, the access device is opened. In a fifth step S5, the limiting device 10 is lowered again for unloading or further loading of objects 6 into the loading area 1. At the same time, depending on the embodiment, the limiting device may be lowered by setting by means of an input device and after loading raised again, or manually lowered by means of handles 13 on the limiting device 10 and raised or pressed down counter to the force of an elastic element 11 by a load or manually. In a sixth step S6, the loading area 1 is unloaded. Alternatively, the loading area 1 in step S6 may also be loaded further.

What is claimed:

1. A limiting device for a loading area of a motor vehicle, wherein the loading area comprises a loading surface and at least one wall which defines the loading area and extends upright, wherein one side of the loading area is accessible for loading and unloading via an access device, and wherein the limiting device is arranged on an accessible side and has a height which is adjustable relative to the loading surface.

2. The limiting device as claimed in claim 1, wherein different heights are able to be set relative to the loading surface.

3. The limiting device as claimed in claim 1, the height thereof being able to be set for loading and unloading, in a region of a loading surface.

4. The limiting device as claimed in claim 3, the height thereof being able to be set a first height that a movement of an object located on the loading surface in a direction of the access device is stopped.

5. The limiting device as claimed in claim 4, which is able to be actively height-adjusted upwardly and downwardly by an acting force.

6. The limiting device as claimed in claim 5, which has at least one elastic element which is elastically deformable by a force in a direction such that the height of the limiting device is approximately set to the height of the loading surface and which adopts an initial state without the force, so that the limiting device adopts a height dictated by a shape of the elastic element.

7. The limiting device as claimed in claim 6, wherein the force is manually exerted in order to adjust the height.

8. The limiting device as claimed in claim 6, wherein the force is mechanically exerted in order to adjust the height.

9. The limiting device as claimed in claim 8, wherein the height is automatically set when the access device is opened, such that an upper end of the limiting device is at a center of gravity of the object on the loading surface.

10. A motor vehicle comprising the limiting device as claimed in claim 1.

11. A limiting device for a loading area of a motor vehicle including a loading surface, an access device and a sill, said limiting device, comprising:
a body extending across said loading surface and being displaceable between a retracted position and a deployed position; and
an elastic element biasing said body toward said deployed position.

12. The limiting device of claim 11, wherein said body is adjacent said sill.

13. The limiting device of claim 12, wherein said body extends above said loading surface when in said deployed position.

14. The limiting device of claim 13, wherein said body extends level with or below said loading surface when in said retracted position.

15. The limiting device of claim 14, further including an indentation provided in one of said loading surface and said sill to receive said body when in said retracted position.

16. The limiting device of claim 15, further including a handle carried on said body.

17. A method for loading and unloading a loading area of a motor vehicle equipped with a limiting device and an access device, comprising:
loading the loading area with an object;
deploying the limiting device;
closing the access device;
opening the access device;
lowering the limiting device; and
unloading the loading area.

18. The method of claim 17, wherein said deploying of said limiting device includes raising said limiting device so as to extend upward from a loading surface of said loading area.

19. The method of claim 18, including positioning said limiting device adjacent a sill of said loading area so that when said limiting device is deployed and raised from said loading surface, said limiting device acts to block said object from rolling across said sill when said access device is opened.

20. The method of claim 19, including extending said limiting device continuously across said sill.
